(19) United States
(12) Patent Application Publication
(10) Pub. No.: US 2007/0128421 A1
(43) Pub. Date: Jun. 7, 2007

(54) Refractory composite

(75) Inventor: Sam Lee, Gardena, CA (US)

Correspondence Address: CURATOLO SIDOTI CO., LPA, 24500 CENTER RIDGE ROAD, SUITE 280, CLEVELAND, OH, 44145, US

(73) Assignee: Hitco Carbon Composites, Inc., Gardena, CA (US)

(21) Appl. No.: 11/602,570

(22) Filed: Nov. 21, 2006

Related U.S. Application Data
(60) Provisional application No. 60/739,192, filed on Nov. 23, 2005.

(51) Int. Cl. B32B 9/00

(52) U.S. Cl. 428/292.1; 428/698

(57) ABSTRACT

A refractory composite article includes a plurality of continuous, polycrystalline stoichiometric silicon carbide reinforcing fibers in an inhibited carbon matrix; the carbon matrix is an organic resin containing an inhibitor compound that has been subjected to carbonization and thereafter to densification by chemical vapor infiltration of at least carbon to form a silicon carbide fiber reinforced carbon composite; and the silicon carbide fiber reinforced carbon composite is coated with a SiC pack cementation coating to form the refractory composite. The pack cementation coating is prepared by providing a pack mixture composition; coating the composite with a release agent; surrounding the release agent-coated composite with the pack mixture composition; and firing the composite to form a protective SiC pack cementation coating on the composite.

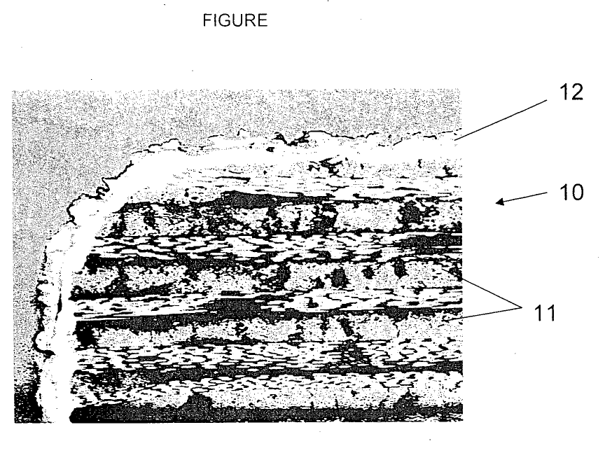

### CROSS-REFERENCE TO RELATED APPLICATIONS

This application claims the benefit of the filing date under 35 U.S.C. § 119(e) of U.S. Provisional Application Ser. No. 60/739,192, filed on Nov. 23, 2005, which is hereby incorporated in its entirety.

### BACKGROUND

Composites of silicon carbide (SiC) fibers in a carbon matrix have been manufactured and used successfully for aircraft flaps and seals on afterburners. These composites utilize amorphous silicon carbide fibers that contain some oxygen, commercial available as ceramic grade Nicalon® fiber from Nippon Carbon. Composites of this type are disclosed in U.S. Pat. No. 5,759,688, which is incorporated by reference as if fully written out below.

Because of the limited heat resistance of the amorphous reinforcing fibers, these composites have a maximum service temperature of 2500° F. (1371° C.). To operate at these temperatures, the composite is generally chemical vapor deposition CVD/SiC coated and may be glazed with an external sealant. Tests indicate that due to the nature of the interface bond between the CVD coating and the amorphous silicon carbide fiber reinforced carbon composite, spallation of the coating may occur under extended heat cycling, and/or salt fog exposure.

### SUMMARY

A refractory composite article is provided having oxidation resistance greater than inhibited carbon/carbon composite materials, comprising a composite of continuous, polycrystalline stoichiometric SiC reinforcing fibers in an inhibited carbon matrix containing an oxidation inhibitor, the composite having a SiC pack cementation coating.

A refractory composite article is provided comprising a plurality of continuous, polycrystalline stoichiometric silicon carbide reinforcing fibers in an inhibited carbon matrix, wherein the carbon matrix comprises an organic resin containing an oxidation inhibitor compound and wherein the organic resin has been subjected to carbonization and thereafter to densification by chemical vapor infiltration of at least carbon to form a silicon carbide fiber reinforced carbon composite, wherein the silicon carbide fiber reinforced carbon composite is coated with a SiC pack cementation coating to form the refractory composite.

A net shaped composite material for structural applications is provided having oxidation resistance greater than inhibited carbon/carbon composite materials, comprising a plurality of continuous, polycrystalline stoichiometric silicon carbide reinforcing fibers in an inhibited carbon matrix containing an oxidation inhibitor, formed by impregnating the fibers with an organic resin and staging to form a prepreg, shaping and curing the prepreg to form a laminate, carbonizing the shaped laminate to form a carbonized part and densifying the carbonized part by chemical vapor infiltration to form a component, wherein prior to the carbonizing, the organic resin contains the oxygen inhibitor compound; and wherein the component is coated with a SiC pack cementation coating.

### BRIEF DESCRIPTION OF THE DRAWING

The FIGURE is a photomicrograph of a sectioned SiC fiber reinforced carbon matrix composite coupon having a pack cementation coating.

### DETAILED DESCRIPTION

It has now been found that the use of polycrystalline, stoichiometric SiC fibers, with the same or a similar carbon matrix will extended the maximum service temperature of the refractory composite to over 3000° F. (1649° C.), while maintaining most of its mechanical properties. The better thermal stability of these polycrystalline SiC reinforcing fibers allow the application of SiC coatings through a reactive pack, (i.e. pack cementation coatings) thus improving the interface bond and resisting coating spallation. The higher coefficient of thermal expansion (CTE) of these polycrystalline SIC fibers are a better match to the CTE of the reactive pack derived pack cementation coatings, and serene to reduce the formation of cooldown cracks in the coatings.

In static oxidation testing, the reactive pack coated substrate showed a very slight weight gain (about 1 g/m²) in 8 hours of exposure at any of 1000° F. (538° C.), 1500° F. (816° C.), or 2000° F. (1093° C.). In 3000° F. (1649° C.) downcycle testing, the reactive pack coated composite showed only small weight gains (about 14 g/m²) in 60 hours (3 cycles), and demonstrated the suitability of this coated composite for hypersonic vehicle applications.

The reactive pack-coated, polycrystalline stoichiometric SiC fiber-reinforced carbon matrix composite system enjoys a performance advantage because of the thermal compatibility, of its constituent elements, and its simplicity. The reactive pack coating converts the surface matrix carbon, and thus has good adhesion to the substrate. With a substantially crack-free surface, no external sealant is required, and less inhibitor in the substrate matrix can be used. Glass formation is expected to be minimal. All of these factors contribute to a reduction in the occurrence of coating spallation.

Lightweight, strong, tough, and oxidation-resistant composites are provided, which maintain their properties even after prolonged high-temperature exposure. The polycrystalline, stoichiometric SiC fiber reinforced carbon composites, having a pack cementation coating, are particularly useful in those applications which require materials capable of withstanding high temperature spikes up to 3200° F. (1760° C.). The net shape fabricability and the ability of the composites to be processed unrestrained permits the production of parts with a wide variety of sizes, shapes and configurations.

Examples of utility for such reactive pack coated, polycrystalline stoichiometric SiC fiber reinforced carbon composites, are structural components for aero engines such as flaps, seals, flame holders and liners; turbine rotors and structural parts for hypersonic vehicles such as bolts, fasteners, skins and leading edges. These composites may also be used as thermal protection materials, such as thermal protection anchorage panels.

The process for manufacturing these SiC/C composites includes the following. Continuous, polycrystalline stoichiometric SiC fibers are impregnated with a thermosetting resin containing fillers. The fibers may then be staged in an oven at about 100° F. to about 220° F. (about 38° C. to about 104° C.) to remove solvents and partially cure the resin. The staged fibers are cut, laid-up as desired, and prepared for molding. The fibers can be molded in a hydraulic press or in an autoclave by conventional procedures for curing phenolic or epoxy laminates. The molded part is then heat-treated at temperatures from about 1000° F. to about 3200° F. (about 538° C. to about 1760° C.) in an inert environment to convert the organic matrix to carbon. The carbonized part is then subjected to a carbon chemical vapor impregnation (CVI) for densification.

SiC fibers usable in this composite article include, but are not limited to, Ube Industries' Tyranno™ series of continuous, polycrystalline stoichiometric SiC fibers, such as Tyranno™ SA-3, Nippon Carbon's Hi-Nicalon™ Type S fiber, and Dow Corning's Sylramic™ fiber. The most suitable polycrystalline, stoichiometric SiC fibers may contain about 0.3% to about 0.8% oxygen by weight, or less. Polycrystalline stoichiometric SiC fibers containing up to about 1% oxygen by weight may be used in the subject composite. In comparison, ceramic grade, amorphous SiC fibers may contain about 10% oxygen by weight, or more. The fibers may take the form of fabric, chopped fabric, yarn, chopped yarn, and tape. SiC yarns may be woven into net shapes by braiding or by multidirectional weaving.

Impregnation of the fibers can take place before or after weaving. The yarn, fabric, and/or tape may be laid flat on a tool and stacked to form a layered reinforcement with the fibers aligned in one or in several directions in the lamina plane. The yarn, fabric, and/or tape may be wrapped or would around a mandrel to form a variety of shape and reinforcement orientations. Fiber volumes in the laminate can range from about 25 to about 60%. By utilizing impregnated fabrics and the like, it is possible to produce structures of complex shapes with a very high degree of fiber orientation and alignment.

The slurries used to impregnate the fibers may comprise phenolic, epoxy, or furan resins containing dispersed filler(s). Representative phenolics include, but are not limited to those supplied under the trademark Durite™ SC1008 by Borden Chemical, Inc. and Arofene™ 134A by Ashland Chemical. Representative epoxies include, but are not limited to, those supplied by Resolution Performance Products under the trademarks Epon 828 and Epon 1031. Representative furans include, but are not limited to, those supplied by Dynachem, Inc., under the trademarks PhenAlloy 440 and PhenAlloy 2160.

The filler(s) used may include, but are not limited to, carbon, boron, boron carbide, boron nitride, silicon, silicon carbide, silicon nitride, silicon tetraboride, silicon hexaboride, titanium diboride, and zirconium diboride, either alone or in combination. Filler volumes in the matrix can range from about 2% to about 25%.

The carbon matrices of the SiC fiber reinforced composites may contain fillers that act as oxidation inhibitors in an amount effective to improve oxidation resistance. These include silicon, boron and the boron containing fillers mentioned above, as well as other boron containing compounds such as refractory metal borides, including those of hafnium, vanadium, niobium, tantalum, chromium, molybdenum and tungsten. In certain embodiments, oxidation inhibitors may be present in the matrix in volumes up to about 25%. In some embodiments, the volume of inhibitor in the matrix may range from about 2% to about 25%. In particular embodiments, the volume of inhibitor in the matrix may range from about 5% to about 15%.

The heat-treatment schedule used to carbonize the organic resin should be slow enough so as not to generate volatiles within the part too quickly, which could cause delaminations. The temperature is to be sufficiently high to convert the resin to predominantly carbon without thermally degrading the reinforcing, fibers. In certain embodiments molded parts are brought from ambient to about 1000° F. to about 3200° F. (about 53° C. to about 1760° C.) in about 50 to about 250 hours.

Chemical vapor infiltration (CVI) is conducted after the composites undergo carbonization, or pyrolysis. One or more infiltrations are required for optimum strength and oxidation resistance. The first CVI is preferably with carbon; subsequent CVI's can be carried out with carbon or SiC. In certain embodiments, at least one CVI is carried out with carbon. Carbon CVI may be conducted with low molecular weight alkanes or alkenes such as methane, ethane, propane, propene, or mixtures thereof such as natural gas at about 1500° F. to about 2200° F. (about 816° C. to about 1204° C.) and a pressure of about 5 to 50 torr (about 670 Pa to 6.670 kPa). SiC CVI may be conducted with methane and silane such as silicon tetrachloride, or wraith an organosilane such as methyltrichlorosilane, dimethyldichlorosilane methyldichlorosilane or their mixtures at about 1600° F. to about 2200° F. (about 871° C. to about 1204° C.) and a pressure of about 2 to about 200 torr (about 267 Pa to about 26.7 kPa).

Carbon, boron nitride, or other coatings can be applied to the fibers to improve the composite's strength and toughness. The coatings should be of a low modulus material layer that can interrupt crack propagation from the matrix into the fiber. Fiber coatings can be applied by chemical vapor deposition, electrochemical, wet chemical, or slurry methods. The fiber coating may be applied directly to the yarn and/or fabric before it is impregnated or in situ after the composite has been heat treated (carbonized).

The present polycrystalline, stoichiometric SiC fiber reinforced carbon composites are particularly suited, because of better thermal stability and higher coefficient of thermal expansion (CTE) of the polycrystalline SiC reinforcing fibers, to the use of reactive pack coating for the SiC fiber reinforced carbon matrix substrate. Reactive pack cementation coatings of carbonaceous substrates, such as carbon/carbon composites, are known. The phrase “pack cementation” as used herein refers to the heat driven conversion of outer surface carbon in a carbon matrix composite to primarily silicon carbide by the infiltration of and reaction with silicon liquid and/or SiO gas supplied by the reactive pack mixture which surrounds the carbonaceous article.

A reactive pack mixture composition useful for the formation of a SiC pack cementation coating for protecting the carbonaceous substrate from degradation at temperatures above about 800° F. (427° C.), that is, the carbon matrix of the composite, comprises in one embodiment, silicon from about 15% to about 50% by weight of the total coating composition; boron from 0°. % to about 25% by weight of the total coating composition when present; SiO₂ from about 0.01% to about 3% by weight of the total coating composition; and SiC from about 40% to about 85% by weight of the total coating composition.

Such coatings may be applied to the SiC/C composites by preparing a reactive pack mixture composition of from about 15% to about 50% silicon, up to about 25% boron if present (B from 0% up to about 25%), from about 0.01% to about 3% SiO₂ and from about 40% to about 85% SiC, all by weight of the total pack mixture composition; coating the SiC/C composite carbonaceous substrate with a release agent; surrounding the release agent-coated carbonaceous substrate with the pack mixture composition; and firing the carbonaceous substrate for a period of time sufficient to effectuate the formation of a protective SiC pack cementation coating on the carbonaceous substrate. A suitable release agent is cork, for providing the clean release of spent pack composition from the carbonaceous substrate, although other release agents may be used.

Elemental silicon can be purchased from Elkem Materials, Inc., as −325 mesh (0.045 mm) powder; the boron, in amorphous form, may be purchased from Tronox, Inc., as Trona™ elemental boron powder; the SiO₂ may be purchased from Atlantic Equipment Engineers as a −325 mesh (<0.045 mm) powder, and the SiC (green) may be purchased from Atlantic Equipment Engineers as a 1200 grit (0.009 mm) powder.

Cork may be purchased with a −200 mesh (<0.074 mm) particle size and a density of between 8 to 10 lbs/ft³(between 128 to 160 kg/m³), from the Maryland Cork Co., Inc. However, a variety of particle sizes and densities will be effective for the purpose stated herein. For ease of application, in certain embodiments, the powdered cork may be mixed with a liquid carrier. Such as 0.4% aqueous solution of xanthan gum. The xanthan gum may be purchased from CP Kelco as Kelzan™-S powder.

The carbonaceous substrate may be placed in a non-reactive retort, surrounded by pack mixture on all sides. Alternatively; the pack-coated substrate may be placed directly into a furnace without first encasing it in a retort. The packed retort, or the pack-coated substrate without the retort, is placed in a furnace, which is heated to a temperature ranging between about 2900° F. and about 3200° F. (about 1593° C. to about 1760° C.). This temperature may then be held for a period of about 2 to about 16 hours, depending on the reactivity of the substrate and the amount of coating pick-up desired. Firing of the substrate may take place in an inert atmosphere, such as argon, in one embodiment at slightly above atmospheric pressure (atmospheric pressure being 101.325 kPa).

The pack mixture composition reacts with the carbonaceous substrate upon firing to convert a portion of the substrate surface into SiC, which protects against the oxidation of the substrate at elevated temperatures, and thus allows the SiC/C composite substrate to maintain its mechanical integrity for longer periods of time.

Reactive pack cementation coating-s are discussed further in U.S. Pat. No. 5,275,983, which is incorporated by reference as if fully written out below.

Continuous, polycrystalline stoichiometric SiC fiber reinforced inhibited carbon composites have significant advantages over conventional ceramic composites. Utilization of an inhibited carbon matrix provides all of the advantages that carbon has over ceramic matrices, such as thermal stability, elasticity and fabricability, while overcoming carbon's disadvantage of poor oxidation resistance. Notched izod impact strengths, which are commonly used to gauge toughness, indicate that SiC fiber reinforced carbon composites are 10 to 100 times more resistant to catastrophic failure than monolithic ceramics.

The SiC fiber reinforced carbon composites can be fabricated into large, complex shapes, and demonstrate mechanical properties suitable for structural applications. Green composite fabrication can be carried out by traditional glass/epoxy molding techniques well known to the aerospace industry. Although carbon/carbon (C/C) composites can be manufactured in a similar manner, they do not offer the high degree of oxidation resistance displayed by the inhibited SiC/C materials, and are subject to catastrophic failure when the coatings are breached.

Additionally, continuous, polycrystalline stoichiometric SiC fiber reinforced carbon composites are more compatible with reactive pack coatings than C/C composites or even amorphous SiC fiber reinforced carbon composites of similar strength, and have greater compressive and interlaminar properties than C/C composites, and greater tensile modulus than amorphous SiC fiber reinforced carbon composites. The oxidation resistance of the SiC fiber reinforced carbon composites is significantly greater than the best inhibited C/C or C/SiC materials, and in many instances better than SiC/SiC composites having fibers with carbon coatings. Temperature resistance of reactive pack coated continuous, polycrystalline stoichiometric SiC fiber reinforced inhibited carbon composites is higher than coated C/C composites or amorphous SiC fiber reinforced inhibited carbon composites.

### EXAMPLE 1

One sheet of 16-inch (40.6 cm) wide by 41.5-inch (105 cm) long 8-harness satin Tyranno™ SA-3 fabric (comprising polycrystalline, stoichiometric silicon carbide fibers) as impregnated with 158 grams of a slurry consisting of 18% boron carbide powder, 52% Ashland Arofene™ 134A (phenolic resin), and 30% isopropyl alcohol (percentages by weight). The molded (phenolic) composite comprised 58.3% fiber, 29.2% resin, and 12.5% boron carbide by weight. The coated sheet was placed in a circulating oven and staged for 30 minutes at 190° F. (88° C.). The staged sheet was cut into 10 rectangular patterns 7.75-inches (19.7 cm) wide by 8.25-inches (21.0 cm) long and stacked with the warp fibers aligned. The stacked plies were sandwiched between two metal plates and sealed in a plastic bag with an exhaust outlet. The bagged part was placed in an autoclave and the exhaust outlet was connected to a vacuum. The autoclave was pressurized to 150 psig (1.03 MPa), brought up to 310° F. (154° C.) in 4 hours and held at 310° F. (154° C.) for 3 hours. The autoclave was then cooled and the consolidated plies were removed. The cured composite as placed in a furnace and brought to 1500° F. (816° C.) in 80 hours in nitrogen. After cool down the part was transferred to a vacuum furnace and brought to 3200° F. (1760° C.) in 22 hours in argon. The pyrolized part vas then infiltrated two times with pyrolytic carbon via a CVI process. The infiltrated composite had a density of 2.23 g/cc (2230 kg/m³), a fiber volume of about 47%, and an inhibitor volume of about 11.5%.

The resulting inhibited SiC/C composite was mechanically tested, and had a tensile strength of 36 ksi (248 MPa), a compressive strength of 48 ksi (331 MPa), a flexural strength of 43 ksi (296 MPa), a tensile modulus of 15 msi (103 GPa), an interlaminar shear strength of 4400 psi (30.3 MPa), and an interlaminar tensile strength of 2300 psi (15.9 MPa).

Seven additional flexural coupons were coated with a release agent and packed in a reactive mixture of 59.5% silicon carbide powder, 35% metallic silicon powder, 5% amorphous boron powder, and 0.5% silicon dioxide powder, in a graphite retort (percentages by weight). The retort was placed in a vacuum furnace, brought up to 2750° F. (1510° C.) in 19 hours and held for one hour, then up to 3200° F. (1760° C.) in 3 hours and held for 8 hours, in argon.

After cool-down, the coupons were extracted. One coupon was tested in flexure, and then sectioned for optical examination. It was found to have a continuous SiC coating averaging 5 mils (0.127 mm) in thickness. The flexural strength, calculated with the coating thickness subtracted from the coupon thickness, was unchanged from that of an uncoated coupon. Static oxidation testing in air at 1000° F. (538° C.), 1500° F. (816° C.), and 2000° F. (1093° C.) for 8 hours showed only minor weight changes. Two hours exposure at 3000° F. (1649° C.) resulted in a weight gain of 8 g/m². Downcycle testing was conducted where a coupon was subjected to 2 hours exposure at 3000° F. (1649° C.) followed by 18 hours at 1200° F. (649° C.) then 16 hours in a humidity chamber set at 95° F. (35° C.) and 95% relative humidity. The cumulative weight gains ere 9 g/m² after the first cycle 12 g/m² after the second cycle, and 14 g/m² after the third cycle.

### EXAMPLE 2

Composites of amorphous silicon carbide fibers in a carbon matrix coated by CVD and of polycrystalline, stoichiometric SiC fibers in a carbon matrix having a reactive pack coating were prepared and tested. A comparison of the properties of the two types of composites, using coated flex coupons, is shown in the table below.

| | Amorphous | Polycrystalline |
|---|---|---|
| Property | SiC | SiC |
| Density (g/cc) | 2.0 | 2.2 |
| In-Plane CTE (×10⁻⁶/° C.)(23-1000° C.) | 4.0 | 4.5 |
| Max Short Term Use Temp (° C.) | 1370 | 1800 |
| Max Long Term Use Temp (° C.) | 1200 | 1600 |
| Tensile Strength (ksi) | 30 | 35 |
| Tensile Modulus (msi) | 9 | 15 |
| Compressive Strength (ksi) | 66 | 47 |
| Flexural Strength (ksi) | 46 | 42 |
| Beam Shear Strength (ksi) | 6.3 | 4.4 |
| Crossply Tensile Strength (ksi) | 3.2 | 2.2 |

A reduction of 22% was observed in the flex strength using the entire coupon thickness in the calculations, but when the coating as subtracted out, there was no change in the flex strength. One of the failed flex coupons as sectioned and examined under high magnification. A micrograph of a flex coupon, comprising a SiC reactive pack-coated polycrystalline, stoichiometric SiC fiber reinforced carbon composite 10, is shown in the FIGURE. The composite article 11, made of stacked plies, had a SiC pack, cementation coating 12. The surfaces are rather irregular. The coating 12 thickness averaged 5 mils (0.127 mm).

The differences between the two types of coated composites are profound. The polycrystalline stoichiometric SiC fiber has greater heat resistance, higher thermal expansion and higher modulus. This results in a stiffer composite that can be used at much higher temperatures, such as 2500° F. (1371° C.) long term, and 3200° F. (1760° C.) short term. More importantly, the polycrystalline stoichiometric SiC fiber reinforced carbon composite can be protected with a reactive pack derived SiC (pack cementation) coating, improving the adhesion between the substrate and coating, and minimizing coating spallation.

The stoichiometric fibers have a coefficient of thermal expansion (CTE) that is a perfect match for the SiC pack cementation coating, resulting in nominally crack free coatings, and minimizing glass formation in SiC coated inhibited carbon matrix composites. Additionally, a 65% improvement in the composite tensile modulus was shown for the composite comprising polycrystalline, stoichiometric SiC fibers in a carbon matrix having the reactive pack derived pack cementation coating.

Although the refractory composite has been described in detail through the above detailed description and the preceding examples, these examples are for the purpose of illustration only and, it is understood that variations and modifications can be made by one skilled in the art without departing from the spirit and the scope of the invention. It should be understood that the embodiments described above are not only in the alternative, but can be combined.

1. A refractory composite article having oxidation resistance greater than inhibited carbon/car-bon composite materials, comprising a composite of continuous, polycrystalline stoichiometric SiC reinforcing fibers in an inhibited carbon matrix containing an oxidation inhibitor, the composite having a SiC pack cementation coating.

2. The article of claim 1, wherein the inhibited carbon matrix contains the oxidation inhibitor from an effective amount to provide oxidation resistance up to about 25 volume percent, the oxidation inhibitor comprising at least one of boron, boron carbide, boron nitride, silicon tetraboride, silicon hexaboride, or zirconium diboride; or refractory metal borides of at least one of hafnium, vanadium, niobium, tantalum, chromium, molybdenum, or tungsten; or mixtures thereof;
optionally wherein the inhibited carbon matrix additionally contains a filler comprising at least one of carbon, silicon carbide, silicon nitride, or mixtures thereof.

3. The article of claim 1, wherein the pack cementation coating is derived from a reactive pack mixture composition comprising:
a) Si from about 15% to about 50% by total weight of the pack mixture composition;
b) B from 0% up to about 25% by total weight of the pack mixture composition;
c) SiO₂ from about 0.01% to about 3% by total weight of the pack mixture composition; and
d) SiC from about 40% to about 85% by total weight of the pack mixture composition.

4. The article of claim 2, wherein the pack cementation coating is derived from a reactive pack mixture composition comprising:
a) Si from about 15% to about 50% by total weight of the pack mixture composition;
b) B from 0% up to about 25% by total weight of the pack mixture composition;
c) SiO₂ from about 0.01% to about 3% by total weight of the pack mixture composition; and
d) SiC from about 40% to about 85% by total weight of the pack mixture composition.

5. The article of claim 1, wherein the fibers comprise fabric, chopped fabric, yarn, chopped yarn, or tape.

6. The article of claim 1, wherein the fiber comprises Tyranno™ SA-3 fiber.

7. The article as in claim 3, wherein the reactive pack mixture composition comprises:
a) from about 25% to about 40% Si by total weight of the pack mixture composition;
b) from about 0% to about 15% B by total weight of the pack mixture composition;
c) from about 0.01% to about 1% SiO₂ by total weight of the pack mixture composition; and
d) from about 44% to about 75% SiC by total weight of the pack mixture composition.

8. The article of claim 1, wherein the pack cementation coating is prepared by
a) providing a reactive pack mixture composition of from about 15% to about 50% Si, 0% up to about 25% B, from about 0.01% to about 3% SiO₂ and from about 40% to about 85% SiC, all by total weight of the pack mixture composition;
b) coating the composite with a release agent;
c) surrounding the release agent-coated composite with the pack mixture composition; and
d) firing the composite for a period of time sufficient to effectuate the formation of a protective SiC pack cementation coating on the composite.

9. The article as in claim 8, wherein the release agent is a slurry comprising cork suspended in a binder-containing liquid carrier, optionally wherein the binder-containing liquid carrier is an aqueous solution of xanthan gum.

10. A refractory composite article comprising a plurality of continuous, polycrystalline stoichiometric silicon carbide reinforcing fibers in an inhibited carbon matrix, wherein the carbon matrix comprises an organic resin containing an oxidation inhibitor compound and wherein the organic resin has been subjected to carbonization and thereafter to densification by chemical vapor infiltration of at least carbon to form a silicon carbide fiber reinforced carbon composite, wherein the silicon carbide fiber reinforced carbon composite is coated with a SiC pack cementation coating to form the refractory composite.

11. The article of claim 10, wherein the inhibited carbon matrix contains the oxidation inhibitor from an effective amount to provide oxidation resistance up to about 25 volume percent, the inhibitor comprising at least one of boron, boron carbide, boron nitride, silicon tetraboride, silicon hexaboride, or zirconium diboride; or refractory metal borides of at least one of hafnium, vanadium, niobium, tantalum, chromium, molybdenum, or tungsten; or mixtures thereof; optionally wherein the inhibited carbon matrix additionally contains a filler comprising at least one of carbon, silicon carbide, silicon nitride, or mixtures thereof.

12. A net shaped composite material for structural applications having oxidation resistance greater than inhibited carbon/carbon composite materials comprising a plurality of continuous, polycrystalline stoichiometric silicon carbide reinforcing fibers in an inhibited carbon matrix containing an oxidation inhibitor, formed by impregnating the fibers with an organic resin and staging to form a prepreg, shaping and curing the prepreg to form a laminate, carbonizing the shaped laminate to form a carbonized part and densifying the carbonized part by chemical vapor infiltration to form a component, wherein prior to the carbonizing, the organic resin contains the oxidation inhibitor; and wherein the component is coated with a SiC pack cementation coating.

13. The shaped material of claim 12, wherein the organic resin comprises at least one of phenolic, epoxy, and furan.

14. The shaped material of claim 12, wherein the oxidation inhibitor comprises at least one of boron, boron carbide, boron nitride, silicon tetraboride, silicon hexaboride, or zirconium diboride; or refractory metal borides of at least one of hafnium, vanadium, niobium, tantalum, chromium, molybdenum, or tungsten; or mixtures thereof; optionally wherein the organic resin additionally contains a filler comprising at least one of carbon, silicon carbide, silicon nitride, or mixtures thereof.

15. The shaped material of claim 12, wherein the fibers comprise fabric, chopped fabric, yarn, chopped yarn, or tape.

16. The shaped material of claim 12, wherein the fibers comprise Tyranno™ SA-3 fiber.

17. A component for an aero engine comprising the refractory composite article of claim 1.

18. The component of claim 17, comprising at least one of flaps, seals, liners or flame holders.

19. A structural part for a hypersonic vehicle comprising the refractory composite article of claim 1.

20. The structural part of claim 19 wherein the structural part comprises at least one of bolts, fasteners, skins or leading edges.

21. A thermal protection material comprising the refractory composite article of claim 1.

22. A component for an aero engine comprising the shaped material of claim 12.

23. The component of claim 22, comprising at least one of flaps, seals, liners or flame holders.

24. A structural part for a hypersonic vehicle comprising the shaped material of claim 12.

25. The structural part of claim 24 wherein the structural part comprises at least one of bolts, fasteners, skins or leading edges.

26. A thermal protection material comprising the shaped material of claim 12.

27. A turbine rotor comprising the refractory composite article of claim 1.

28. A turbine rotor comprising the shaped material of claim 12.
